(19) United States
(12) Patent Application Publication
(10) Pub. No.: US 2006/0033937 A1
(43) Pub. Date: Feb. 16, 2006

(54) Image forming apparatus and method for printing images at sizes designated by countries

(75) Inventor: Hee-kyung Hwang, Gyeonggi-do (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/203,294

(22) Filed: Aug. 15, 2005

(30) Foreign Application Priority Data
Aug. 14, 2004 (KR) 10-2004-0064125

(51) Int. Cl. G06K 15/02

(52) U.S. Cl. 358/1.2

(57) ABSTRACT

An image forming apparatus and method for printing images at image sizes designated by countries are provided. The apparatus includes a storage unit for storing image sizes respectively designated by a plurality of countries; a user input unit for receiving information on the size of an image to be printed; and a printing unit for printing the image at one of the image sizes stored in the storage unit according to the information on the size of the image to be printed. In the image forming apparatus and method, sizes of images such as photographs, which are designated differently by different countries, are pre-stored in the storage unit of the image forming apparatus, and a user selects one of the stored sizes when printing, thereby conveniently printing images at sizes designated by countries.

### BACKGROUND OF THE INVENTION

This application claims the benefit under 35 U.S.C. 119(a) of Korean Patent Application No. 10-2004-0064125, filed on Aug. 14, 2004, in the Korean Intellectual Property Office, the entire disclosure of which is incorporated hereby by reference.

1. Field of the Invention

The present invention relates to an image forming apparatus and method. More particularly, the present invention relates to an image forming apparatus and method for printing images at sizes designated by countries.

2. Description of the Related Art

Image forming apparatuses receive image data made by users via an application program in a personal computer (PC) and print images on paper.

Data processing and printing technologies have advanced to the point where an image forming apparatus can print an image with a high resolution, thus allowing for the printing of sharp film-like photographs. Accordingly, users can easily print images which are photographed by digital cameras using image forming apparatuses and use the digital images as traditional photographs.

In a method in which images photographed by digital cameras are printed by image forming apparatuses, a digital camera is connected to a PC by a cable and image data stored in the digital camera are printed by the image forming apparatus, or image data stored in the digital camera is stored in the PC to be printed via an image forming apparatus connected to the PC at a user's convenience. It is also possible to print an image without having a PC connected to an image forming apparatus. A digital camera or a memory card such as a smart media card (SMC) which is an image data storage unit of a digital camera, is directly connected to an image forming apparatus to print stored image data.

When an image is printed by an image forming apparatus to be used as a traditional photograph, printing image sizes set in image forming apparatuses are uniform in spite of differences in photograph sizes designated by different countries according to the use of the photographs. For example, although the photograph size for Korean passports is different from the photograph size for Japanese passports, printing image sizes are set as 3×5″, 4×6″, or 5×7″ regardless of the countries for which the photographs are taken in the image forming apparatus. Accordingly, in order to print a photograph with a size designated by a country for a specific use, a user has to select a photograph size manually in the image forming apparatus, and when the designated size cannot be set in the image forming apparatus, a user has to set the size using a PC.

Therefore, there is a need for an apparatus and method for pre-selecting image sizes based on a designated country's size format.

### SUMMARY OF THE INVENTION

The present invention provides an image forming apparatus in which sizes of images such as photographs, designated differently by different countries, are pre-stored in a storage unit of the image forming apparatus, and users can select one of the stored sizes when printing, thereby conveniently printing images at sizes designated by countries, and a method using for using the same.

According to an aspect of the present invention, there is provided an image forming apparatus which prints images with predetermined image sizes. The image forming apparatus comprises a storage unit for storing image sizes respectively designated by a plurality of countries; a user input unit for receiving information on the size of an image to be printed; and a printing unit for printing the image at one of the image sizes stored in the storage unit, according to the information on the size of the image to be printed.

The image sizes stored in the storage unit may comprise passport photograph sizes designated by a country. The apparatus may further comprise an interface unit which is connected to external equipment to receive information on the image sizes designated by countries from the external equipment and stores the information in the storage unit.

The interface unit may receive from the external equipment information on image sizes designated by a country in which a language set by a user is used.

The user input unit may receive information regarding a country and the image size of an image to be printed from the user. The information regarding a country may be a language used in the country.

The apparatus may further comprise a display unit which displays the image sizes designated by the countries stored in the storage unit.

According to another aspect of the present invention, there is provided an image forming method in which images are printed with image sizes stored in a storage unit, comprising receiving a selection of one of the image sizes designated by at least one of a plurality of countries stored in the storage unit; and printing images at the selected image size.

The sizes stored in the storage unit may comprise passport photograph sizes designated by a country. The method may further comprise the operation of receiving information on the image designated by countries from external equipment and storing the information in the storage unit.

The method may further comprise receiving a language selection from a user; and receiving from the external equipment information on image sizes designated by a country in which the language is used and storing the information in the storage unit.

The receiving of the selection of one of the printing sizes of the at least one of the countries comprises receiving information regarding the at least one of the countries; and receiving the selection of the one of the printing sizes designated by the at least one of the countries. The information regarding the at least one of the countries may be a language used in the at least one of the countries.

The method may further comprise the operation of displaying the printing image sizes designated by the countries stored in the storage unit.

The method may be implemented using a computer readable recording medium which records a computer program.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an image forming apparatus according to an embodiment of the present invention;

FIG. 2 is a block diagram of an image forming apparatus comprising an interface unit which receives image size, designated by countries from a personal computer (PC);

FIG. 3 is a flow chart illustrating an image forming method according to an embodiment of the present invention;

FIG. 4 is a flow chart illustrating an image forming method in which the name of a country is selected by a user, the size of an image is set, and the image is printed; and

FIG. 5 is a flow chart illustrating an image forming method in which image sizes designated by countries are input from a PC and stored in a storage unit.

Throughout the drawings, the same or similar elements, features and structures are represented by the same reference numerals.

### DETAILED DESCRIPTION OF EXEMPLARY EMBODIMENTS

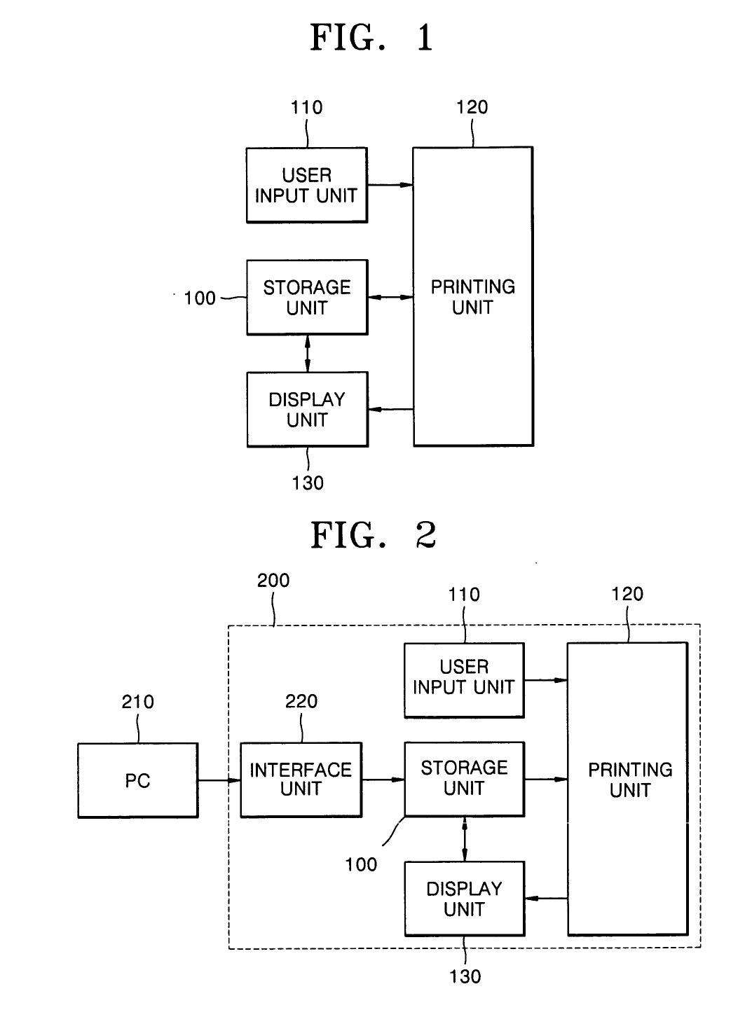

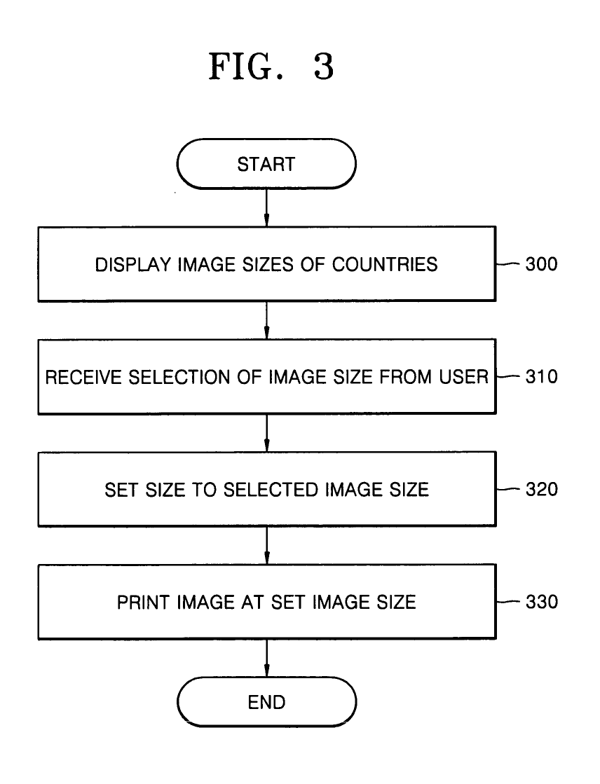

FIG. 1 is a block diagram of an image forming apparatus according to an embodiment of the present invention. The image forming apparatus comprises a storage unit 100, a user input unit 110, a printing unit 120, and a display unit 130. The operation of the image forming apparatus will now be described with reference to FIG. 3.

The storage unit 100 stores image sizes designated by countries, and the image size of each country may be transferred to the storage unit 100 from a compact disk (CD), for example, which is provided with an image forming apparatus using a personal computer (PC) 210 (see FIG. 2) connected to the image forming apparatus or may be downloaded via the Internet by the PC 210.

The display unit 130 displays printing image sizes designated by countries and stored in the storage unit 100 at step 300 in FIG. 3. The stored image sizes designated by the countries may comprise the photograph sizes for passports designated by the countries. The display unit 130 may be a light emitting diode (LED) or a liquid crystal display (LCD). A user checks the image sizes of the countries stored in the storage unit 100 via the display unit 130 and can select one of the displayed image sizes for printing.

The user input unit 110 receives the selection of the image size from the user at step 310.

The printing unit 120 sets the size of an image to be printed to the selected image size at step 320 and prints the image at step 330.

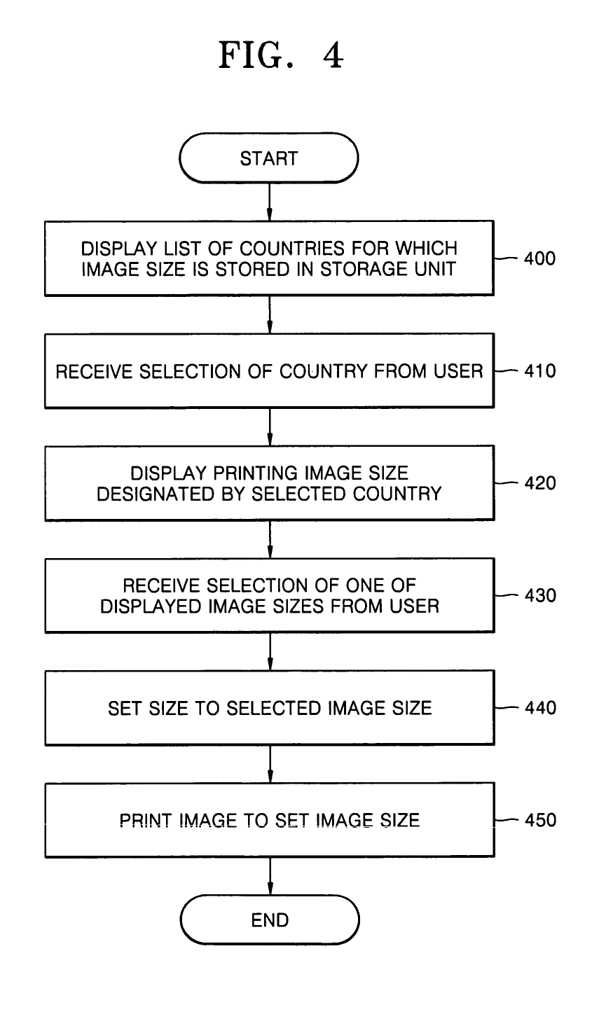

FIG. 4 is a flow chart illustrating an image forming method in which the name of a country is selected by a user, the size of an image is set, and the image is printed.

The display unit 130 displays a list of countries for which designated image sizes are stored in the storage unit 100 at step 400. The user selects the name of a country in which the image to be printed will be used from the list of countries displayed on the display unit 130.

The user input unit 110 receives the selection of one of the countries from the user at step 410. The user may select a display language in the image forming apparatus via the user input unit 110, thereby selecting a country in which the image to be printed will be used.

The display unit 130 displays printing image sizes designated by the selected country at step 420. The user input unit 110 receives the selection of an image size for printing from the user (S430).

The printing unit 120 sets the size of the image to be printed to the selected image size at step 440 and prints the image at step 450.

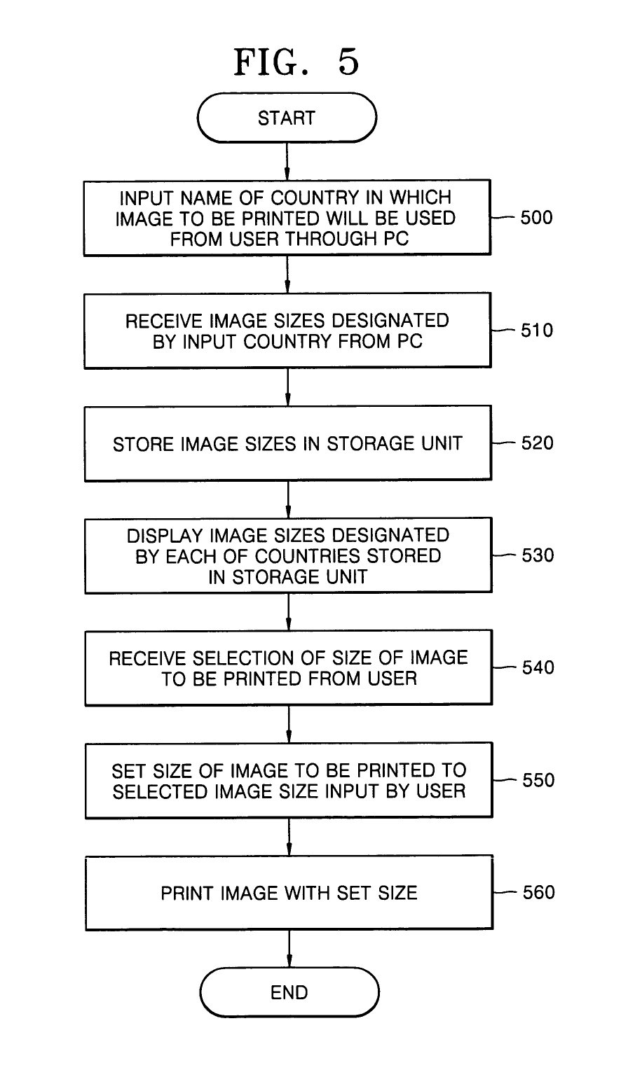

FIG. 2 is a block diagram of an image forming apparatus comprising an interface unit which receives image sizes for various countries from a PC according to an embodiment of the present invention. The image forming apparatus 200 comprises the storage unit 100, the user input unit 110, the display unit 130, and an interface unit 220. The operation of the image forming apparatus of FIG. 2 will now be described with reference to FIG. 5, which is a flow chart illustrating an image forming method in which image sizes of countries are input from a PC and stored in the storage unit 100 to print images.

A PC recognizes a CD, DVD, disk, and the like in which printing image sizes designated by countries are stored or is connected to the Internet, and the user inputs the name of the country in which the image to be printed will be used into the PC 210 at step 500.

The user selects a display language in the image forming apparatus 200 using the PC 210, thereby selecting a country in which the image to be printed will be used.

The interface unit 220 is connected to the PC 210 and receives an image size designated by the selected country at step 510 and stores the image size in the storage unit 100 at step 520.

The display unit 130 displays image sizes designated by each of the countries stored in the storage unit 100 at step 530. The user input unit 110 receives a selection of the size of the image to be printed from the user at step 540. The printing unit 120 sets the size of the image to be printed to the selected image size input by the user at step 550 and prints the image at step 560.

As described above, in the image forming apparatus and method according to the embodiment of the present invention, sizes of images such as photographs designated by countries are pre-stored in the storage unit of the image forming apparatus, and a user selects one of the stored sizes when printing images, thereby conveniently printing images at sizes designated by specific countries.

The embodiment of the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to an exemplary embodiment thereof, it will be understood by those of ordinary skill in the art that various changes in form and details may be made therein without departing from the spirit and scope of the present invention as defined by the following claims.

What is claimed is:

1. An image forming apparatus which prints images with predetermined image sizes, comprising:
a storage unit for storing image sizes respectively designated by a plurality of countries;
a user input unit for receiving information on the size of an image to be printed; and
a printing unit for printing the image at one of the image sizes stored in the storage unit, according to the information on the size of the image to be printed.

2. The apparatus of claim 1, wherein the image sizes stored in the storage unit comprise at least one among different passport photograph sizes designated by a country, a card size, a half card size, L(3×5″), and 2L(5×7″).

3. The apparatus of claim 1, further comprising an interface unit for connecting to external equipment for receiving information on the image sizes designated by countries from the external equipment and storing the information in the storage unit.

4. The apparatus of claim 3, wherein the interface unit receives from the external equipment information on image sizes designated by a country in which a language set by a user is used.

5. The apparatus of claim 1, wherein the user input unit receives information regarding a country and the image size of an image to be printed from the user.

6. The apparatus of claim 5, wherein the information regarding a country is a language used in the country.

7. The apparatus of claim 1, further comprising a display unit for displaying the image sizes designated by the countries stored in the storage unit.

8. An image forming method in which images are printed with image sizes stored in a storage unit, comprising:
receiving a selection of one of the image sizes designated by at least one of a plurality of countries stored in the storage unit; and
printing images at the selected image size.

9. The method of claim 8, wherein the sizes stored in the storage unit comprise at least one among different passport photograph sizes designated by a country, a card size, a half card size, L(3×5″), and 2L(5×7″).

10. The method of claim 8, further comprising the operation of receiving information on the image designated by countries from external equipment and storing the information in the storage unit.

11. The method of claim 8, further comprising:
receiving a language selection from a user; and
receiving from the external equipment information on image sizes designated by a country in which the language is used and storing the information in the storage unit.

12. The method of claim 8, wherein the step of receiving the selection of one of the printing sizes of the at least one of the countries comprises:
receiving information regarding the at least one of the countries; and
receiving the selection of the one of the printing sizes designated by the at least one of the countries.

13. The method of claim 12, wherein the information regarding the at least one of the countries is a language used in the at least one of the countries.

14. The method of claim 8, further comprising the operation of displaying the printing image sizes designated by the countries stored in the storage unit.

15. A computer readable recording medium on which a program executing the method of claim 8 in a computer is recorded.
